(19) United States
(12) Patent Application Publication
(10) Pub. No.: US 2015/0252841 A1
(43) Pub. Date: Sep. 10, 2015

(54) BEARING ASSEMBLY WITH INTEGRATED SPRING

(71) Applicant: Schaeffler Technologies AG & Co. KG, Herzogenaurach (DE)

(72) Inventor: Michael HEATON, Rock Hill, SC (US)

(73) Assignee: SCHAEFFLER TECHNOLOGIES AG & CO. KG, Herzogenaurach (DE)

(21) Appl. No.: 14/615,036

(22) Filed: Feb. 5, 2015

Related U.S. Application Data
(60) Provisional application No. 61/948,211, filed on Mar. 5, 2014.

(51) Int. Cl. F16C 25/08; F16C 35/077; F16C 43/04; F16C 35/073; F16C 19/06; F16C 19/36

(52) U.S. Cl. CPC F16C 25/08; F16C 19/06; F16C 19/364; F16C 43/04; F16C 35/073; F16C 35/077

(57) ABSTRACT

A rolling bearing assembly is provided that includes an inner bearing ring adapted to receive a radially outer surface of a shaft and an outer bearing ring adapted to be supported on a radially inner surface of a housing. A plurality of rolling elements are supported between the inner ring and the outer ring. The inner ring defines an inner race on which the plurality of rolling elements run, and the outer ring defines an outer race on which the plurality of rolling elements run. A recess is formed on at least one of a radially inner surface of the inner bearing ring or a radially outer surface of the outer bearing ring. A spring is arranged at least partially in the recess and biases at least one of the inner bearing ring or the outer bearing ring against a respective one of the shaft or the housing.

### INCORPORATION BY REFERENCE

The following documents are incorporated herein by reference as if fully set forth: U.S. Provisional Patent Application No. 61/948,211, filed Mar. 5, 2014.

### FIELD OF INVENTION

This invention is generally related to a bearing assembly and more particularly related to an element for compensating thermal expansion of bearing supporting components and/or bearing supported components.

### BACKGROUND

Rolling bearing assemblies are used in a wide variety of mechanical applications. One type of rolling bearing assembly includes an inner ring supported on the outside of a shaft, an outer ring supported on the inside of a housing, and a plurality of rolling elements that run on the facing surfaces of the inner ring and the outer ring. The inner ring, outer ring, and rolling elements are typically formed form bearing-grade steel. The housing and the shaft can be formed from a variety of materials depending on the application. If the housing and the shaft are formed from different materials, then the housing and shaft have different thermal expansion coefficients. The difference in thermal expansion coefficients can cause issues regarding radial clearances between the bearing supporting and/or bearing supported components when the assembly transitions from an initial startup condition to a running condition. Inadequate contact between the bearing and these components may allow free-spinning of the bearing inner or outer ring relative to the supporting and/or supported components resulting in high friction spalling, and wear of the components rather than the low friction interface intended through the use of the rolling bearing.

### SUMMARY

It would be desirable to provide a simple way to effectively compensate different thermal expansion coefficients of bearing supporting and/or supported components and to prevent free-spinning of a bearing ring against a mounting surface of a shaft or housing during an initial startup condition or during operation. This is achieved according to the invention by providing a spring integrated into a rolling bearing assembly that applies a fixing force between the bearing ring and the shaft and/or the housing.

In a preferred arrangement, a rolling bearing assembly is provided that includes an inner bearing ring adapted to receive a radially outer surface of a shaft, and an outer bearing ring adapted to be supported on a radially inner surface of a housing. A plurality of rolling elements are supported between the inner ring and the outer ring. The inner ring defines an inner race on which the plurality of rolling elements run, and the outer ring defines an outer race on which the plurality of rolling elements run. A recess is formed on at least one of a radially inner surface of the inner bearing ring or a radially outer surface of the outer bearing ring. A spring is arranged at least partially in the recess and is biased against a respective one of the shaft or the housing to provide a sufficient force to hold the inner and/or outer ring in a fixed position relative to the shaft or the housing.

A method of preventing free-spinning of a bearing ring on a mounting surface of a shaft or housing is also provided. The method includes providing a bearing assembly with an inner bearing ring, and an outer bearing ring, a plurality of rolling elements located between the inner ring and the outer ring, and the plurality of rolling elements run on an inner race on the inner ring and an outer race on the outer ring. A recess is provided on at least one of a radially inner surface of the inner bearing ring or a radially outer surface of the outer bearing ring, and a spring is installed at least partially in the recess. The method further includes installing the bearing assembly such that the spring is preloaded against a respective one of the shaft or the housing.

Preferred arrangements with one or more features of the invention are described below and in the claims.

### BRIEF DESCRIPTION OF THE DRAWINGS

The foregoing Summary as well as the following Detailed Description will be best understood when read in conjunction with the appended drawings. In the drawings:

FIG. 1 is cross-sectional view of a rolling bearing assembly with a spring in a first, expanded state according to the present invention.

FIG. 2 is side perspective cross-sectional view of the rolling bearing assembly of FIG. 1 prior to installation with a shaft and housing.

FIG. 3 is perspective view of the spring of the rolling bearing assembly of FIGS. 1 and 2.

FIG. 4 is cross-sectional view of the rolling bearing assembly of FIGS. 1 and 2 with the spring in a second, compressed state.

### DETAILED DESCRIPTION OF THE PREFERRED EMBODIMENTS

Certain terminology is used in the following description for convenience only and is not limiting. The words “inner,” “outer,” “inwardly,” and “outwardly” refer to directions towards and away from the parts referenced in the drawings. A reference to a list of items that are cited as “at least one of a, b, or c” (where a, b, and c represent the items being listed) means any single one of the items a, b, c, or combinations thereof. The terminology includes the words specifically noted above, derivates thereof, and words of similar import.

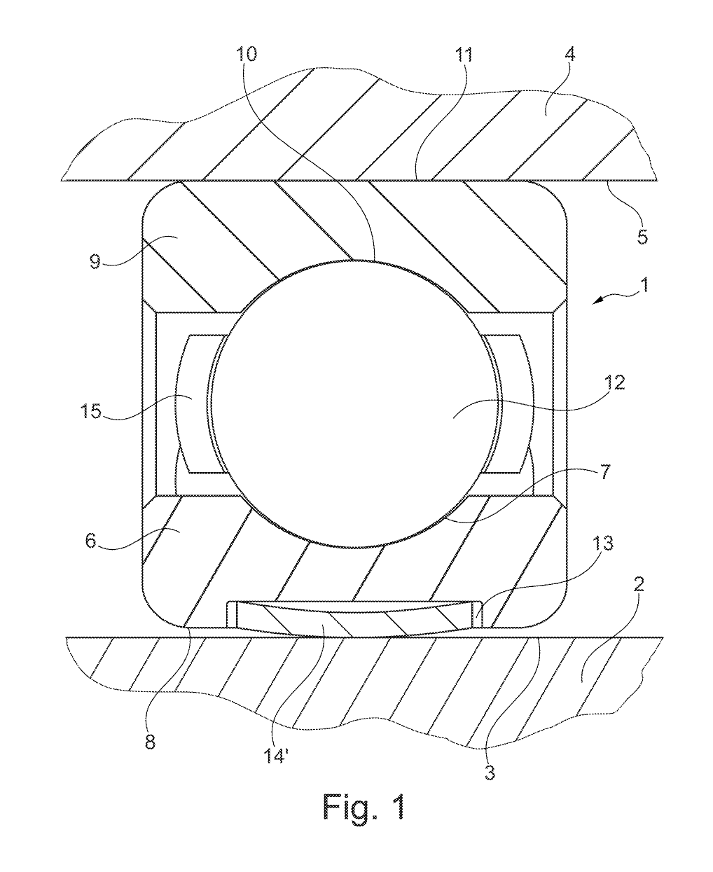

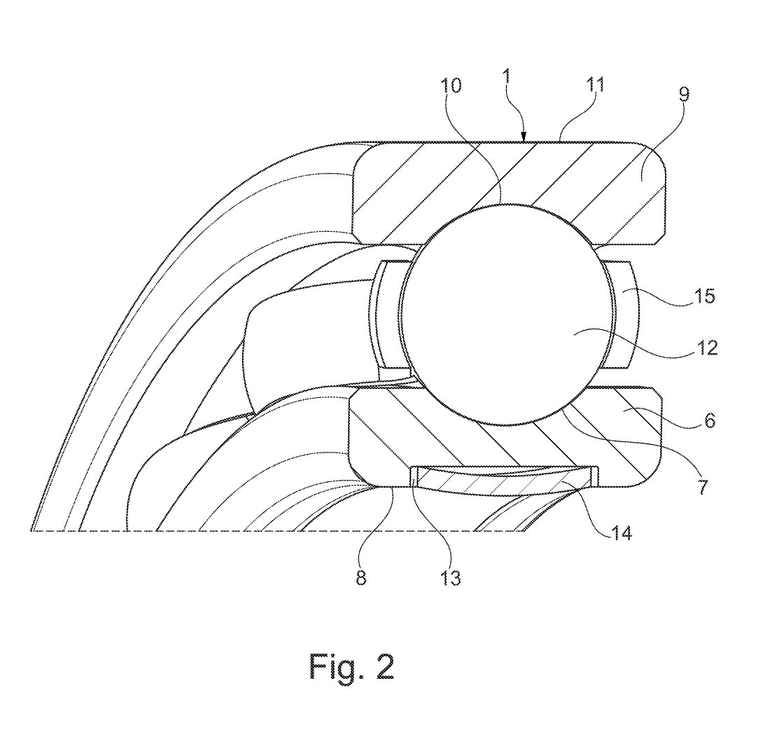

As shown in FIGS. 1, 2, and 4, a rolling bearing assembly 1 is provided. The rolling bearing assembly 1 includes an inner bearing ring 6 adapted to receive a radially outer surface 3 of a shaft 2 and an outer bearing ring 9 adapted to be supported on a radially inner surface 5 of a housing 4. A plurality of rolling elements 12 are supported between the inner ring 6 and the outer ring 9. The plurality of rolling elements 12 can be spherical rolling elements, cylindrical rollers, or tapered rollers. The inner ring 6 defines an inner race 7 on which the plurality of rolling elements 12 run, and the outer ring 9 defines an outer race 10 on which the plurality of rolling elements 12 run. The inner bearing ring 6, outer bearing ring 9, and plurality of rolling elements 12 are preferably formed from bearing-grade steel. In one embodiment, the bearing assembly 1 includes a cage 15 for the plurality of rolling elements 12. The cage 15 can be formed from a variety of materials, including, but, not limited to brass, steel, or various types of plastic. In a preferred embodiment, the shaft 2 and housing 4 are formed from different materials, and have different thermal expansion coefficients, which can cause radial clearances to increase, depending on the operating condition, between the rolling bearing assembly and the housing 4 and/or the shaft 2 that can compromise the function of the overall assembly.

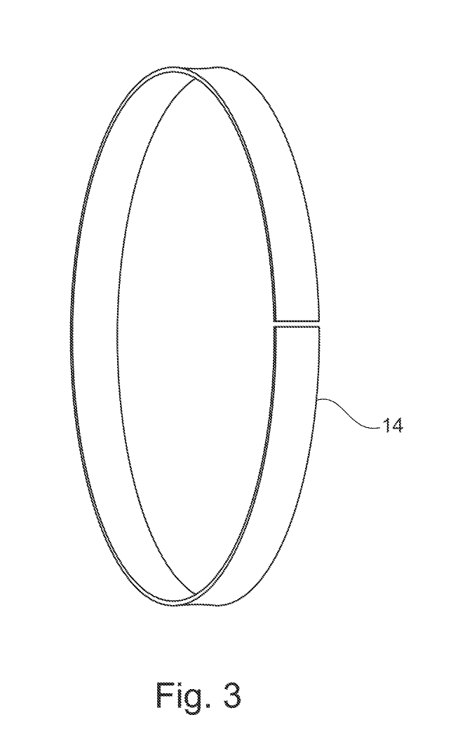

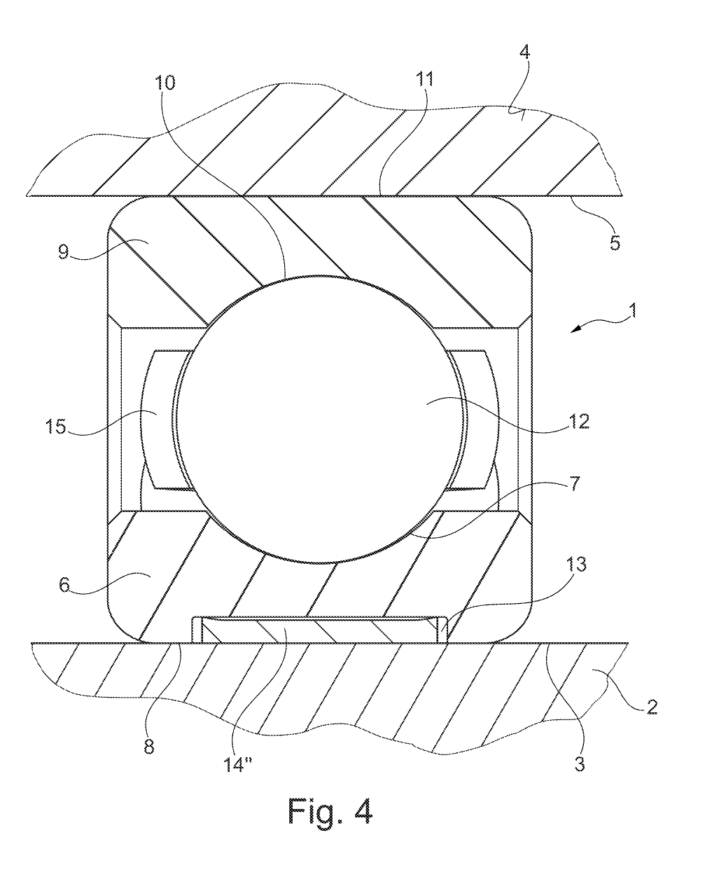

In order to accommodate the radial clearances between the inner ring 6 and/or outer ring 9 and the housing 4 and/or the shaft 2, a recess 13 and a spring 14 are provided to create a fixing force between at least one of the outer bearing ring 9 and the housing 4 or the inner bearing ring 6 and the shaft 2. FIGS. 1, 2, and 4 show the recess 13 being formed on the radially inner surface inner bearing ring 8, however, the recess 13 can be formed on at least one of a radially inner surface of the inner bearing ring 8 or a radially outer surface of the outer bearing ring 11. The recess 13 preferably extends a sufficient depth radially into at least one of the inner bearing ring 6 or the outer bearing ring 9 to accommodate a thickness of the spring 14. One of ordinary skill in the art recognizes that any suitable shape or size can be used for the recess 13, depending on the bearing geometry and application. The spring 14 shape, thickness, stiffness, material, surface finish, coating material, and other properties can also be varied to accommodate a specific bearing geometry or application. The spring 14 has a bowed cross-section, and is arranged at least partially in the recess 13 and, upon installation, is at least partially compressed to create a fixing force between the inner bearing ring 6 or the outer bearing ring 9 against a respective one of the shaft 2 or the housing 4. FIG. 3 shows the spring 14 in a perspective view, prior to assembly with a rolling bearing assembly 1. The spring 14 is preferably formed from spring steel, and has a stiffness that provides a preload. The spring 14 is adapted to move from a first, expanded state (shown in FIG. 1 as 14′) in a first operating condition, in which the preloaded spring 14 compensates for any increased clearance, and as the clearance is reduced due to thermal expansion of the various parts, the spring 14 is compressed into the recess 13 in a second, compressed state (shown in FIG. 4 as 14″) in a second operating condition in which at least one of the shaft 2 or the housing 4 has expanded.

In a first embodiment, the housing 4 is formed from aluminum, the spring 14 is arranged in the radially outer surface of the outer bearing ring 11, and the spring 14 engages against the housing 4 to provide a fixing force between the housing 4 and the outer bearing ring 9. In this embodiment, during a first operating condition, e.g. an initial startup condition, the spring 14 is in a first, expanded state and provides a first preload between the housing 4 and outer bearing ring 9 such that the outer bearing ring 9 is held fixed, and does not spin in the housing 4. During a second operating condition, e.g. once the engine has been running and the housing 4 is heated, the radial clearance between the housing 4 and the outer bearing ring 9 decreases due to radially inward expansion of the housing 4, and the spring 14 moves to a second, compressed state and provides a second preload that is greater than the first preload between the housing 4 and the outer bearing ring 9. Alternatively, in the second operating condition, the radial clearance between the housing 4 and the outer bearing ring 9 can increase due to radially outwardly expansion of the housing 4, and the spring 14 provides a second preload that is less than the first preload between the housing 4 and the outer bearing ring 9. The second preload is still sufficient to provide a fixing force between the housing 4 and the outer bearing ring 9.

In a second embodiment, the shaft 2 is formed from a material with a higher thermal coefficient than the bearing, such as aluminum, the spring 14 is arranged in the radially inner surface of the inner bearing ring 8, and the spring 14 engages against the shaft 2 to provide the required fixing force between the shaft 2 and the inner bearing ring 6. In this embodiment, during a first operating condition, e.g. an initial startup condition, the spring 14 is in a first, expanded state and provides a first preload between the shaft 2 and the inner bearing ring 6 such that the inner bearing ring 6 is held fixed and does not spin free on the shaft 2. During a second operating condition, e.g. once the engine has been running and the shaft 2 is heated, the shaft 2 expands radially outwardly and the spring 14 is in a second, compressed state and provides a second, higher preload between the shaft 2 and the inner bearing ring 6 that is greater than the first preload.

A method of preventing free-spinning of a bearing ring and a mounting surface of a shaft 2 or housing 4 is also provided. The method includes providing a bearing assembly 1 with an inner bearing ring 6 and an outer bearing ring 9, and a plurality of rolling elements 12 located between the inner ring 6 and the outer ring 9. The plurality of rolling elements 12 run on an inner race 7 on the inner ring 6 and an outer race 10 on the outer ring 9. A recess 13 is provided on at least one of a radially inner surface of the inner bearing ring 8 or a radially outer surface of the outer bearing ring 11, and a spring 14 is installed at least partially in the recess. The method includes installing the bearing assembly 1 such that the spring 14 is preloaded against a respective one of the shaft 2 or the housing 4. In one embodiment, during a first operating condition the spring 14 is in a first, expanded state 14′ and provides a fixing force to hold at least one of the inner bearing ring 6 or the outer bearing ring 9 against a respective one of the shaft 2 or the housing 4. During a second operating condition the spring 14 is in a second, compressed state 14″ due to thermal expansion of at least one of the shaft 2 or the housing 4.

Having thus described various embodiments of the present rolling bearing assembly in detail, it is to be appreciated and will be apparent to those skilled in the art that many changes, only a few of which are exemplified in the detailed description above, could be made in the device without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

### LOG TO REFERENCE NUMBERS

1. Rolling Bearing Assembly

2. Shaft

3. Radially Outer Surface of Shaft

4. Housing

5. Radially Inner Surface of Housing

6. Inner Bearing Ring

7. Inner Race

8. Radially Inner Surface of Inner Bearing Ring

9. Outer Bearing Ring

10. Outer Race

11. Radially Outer Surface of Outer Bearing Ring

12. Plurality of Rolling Elements

13. Recess

14. Spring

14′. Spring in first, expanded state

14″. Spring in second, compressed state

15. Cage

What is claimed is:

1. A rolling bearing assembly comprising:
an inner bearing ring adapted to receive a radially outer surface of a shaft;
an outer bearing ring adapted to be supported on a radially inner surface of a housing;
a plurality of rolling elements supported between the inner ring and the outer ring, the inner ring defines an inner race on which the plurality of rolling elements run, and the outer ring defines an outer race on which the plurality of rolling elements run;
a recess formed on at least one of a radially inner surface of the inner bearing ring or a radially outer surface of the outer bearing ring; and
a spring arranged at least partially in the recess that is biased against a respective one of the shaft or the housing.

2. The rolling bearing assembly of claim 1, wherein the bearing assembly includes a cage for the plurality of rolling elements.

3. The rolling bearing assembly of claim 1, wherein the spring is formed from spring steel.

4. The rolling bearing assembly of claim 1, further comprising a housing formed from aluminum in which the outer ring is supported, and the spring engages with a preload against the housing.

5. The rolling bearing assembly of claim 1, further comprising a shaft formed from aluminum, supported by the inner ring, and the spring engages with a preload against the shaft.

6. The rolling bearing assembly of claim 1, wherein the recess extends a distance at least equal to a thickness of the spring radially into at least one of the inner bearing ring or the outer bearing ring.

7. The rolling bearing assembly of claim 1, wherein the plurality of rolling elements are spherical rolling elements.

8. The rolling bearing assembly of claim 1, wherein the plurality of rolling elements are tapered rollers.

9. The rolling bearing assembly of claim 4, wherein the housing and the shaft are formed from different materials.

10. The rolling bearing assembly of claim 5, wherein the housing and the shaft are formed from different materials.

11. The rolling bearing assembly of claim 4, wherein the spring is adapted to move from a first, expanded state in a first operating condition, to a second, compressed state in a second operating condition due to thermal expansion of the housing.

12. The rolling bearing assembly of claim 4, wherein the spring is adapted to move from a first, compressed state in a first operating condition, to a second, expanded state in a second operating condition due to thermal expansion of the housing.

13. The rolling bearing assembly of claim 5, wherein the spring is adapted to move from a first, expanded state in a first operating condition, to a second, compressed state in a second operating condition due to thermal expansion of the shaft.

14. A method of preventing free-spinning of a bearing ring and a mounting surface of a shaft or housing, the method comprising:
providing a bearing assembly including an inner bearing ring, an outer bearing ring, a plurality of rolling elements between the inner ring and the outer ring that run on an inner race on the inner ring and an outer race on the outer ring, a recess on at least one of a radially inner surface of the inner bearing ring or a radially outer surface of the outer bearing ring, and a spring is installed at least partially in the recess; and
installing the bearing assembly such that the spring is preloaded against a respective one of the shaft or the housing.

15. The method of claim 14, wherein the recess is provided on the radially inner surface of the inner bearing ring and the shaft is formed from a material having a higher coefficient of thermal expansion than the bearing, and during a first operating condition the spring is in a first, expanded state and provides a first preload between the inner bearing ring and the shaft, and during a second operating condition the spring is in a second, compressed state and provides a second preload between the inner bearing ring and the shaft due to thermal expansion of the shaft, wherein the first preload is less than the second preload.

16. The method of claim 14, wherein the recess is provided on the radially outer surface of the outer bearing ring and the housing is formed from a material having a higher coefficient of thermal expansion than the bearing, and during a first operating condition the spring is in a first, expanded state and provides a first preload between the outer bearing ring and the housing, and during a second operating condition the spring is in a second, compressed state and provides a second preload between the outer bearing ring and the housing due to thermal expansion of the housing, wherein the first preload is less than the second preload.

17. The method of claim 14, wherein the recess is provided on the radially outer surface of the outer bearing ring and the housing is formed from a material having a lower coefficient of thermal expansion than the bearing, and during a first operating condition the spring is in a first, compressed state and provides a first preload between the outer bearing ring and the housing, and during a second operating condition the spring is in a second, expanded state and provides a second preload between the outer bearing ring and the housing due to thermal expansion of the housing, wherein the first preload is greater than the second preload.
